(19) United States
(12) Patent Application Publication
(10) Pub. No.: US 2022/0219446 A1
(43) Pub. Date: Jul. 14, 2022

(54) PRINT CONTROL STRIP

(71) Applicant: manroland Goss web systems GmbH, Augsburg (DE)

(72) Inventor: Wolfgang Hiesinger, Biberbach (DE)

(73) Assignee: manroland Goss web systems GmbH, Augsburg (DE)

(21) Appl. No.: 17/571,452

(22) Filed: Jan. 8, 2022

(30) Foreign Application Priority Data
Jan. 8, 2021 (EP) 21150766.0

(51) Int. Cl. B41F 33/00

(52) U.S. Cl. CPC B41F 33/0081

(57) ABSTRACT

A print control strip for printing onto a substrate, which moves in a printing direction X during a printing process, with a substrate width B, which extends perpendicularly to the printing direction X, wherein the print control strip extends at least over a portion of the substrate width B, wherein the print control strip has at least one row in the printing direction X, and wherein one or each row has a plurality of measuring fields arranged next to one another perpendicularly to the printing direction X, and wherein each measuring field has a center of area and a leading edge in the printing direction X. The center of area or the leading edge of at least one measuring field is arranged to be offset in or opposite to the printing direction X to the center of area or leading edge of an adjacent measuring field of the same row.

### FIELD OF THE INVENTION

The invention relates to a print control strip for printing onto a substrate, which moves in a printing direction X during a printing process, with a substrate width B, which extends perpendicularly to the printing direction X, wherein the print control strip extends at least over a portion of the substrate width B, wherein the print control strip comprises at least one row in the extension of the printing direction X, and wherein one or each row comprises a plurality of measuring fields arranged next to one another perpendicularly to the printing direction X, and wherein each measuring field has a center of area and an edge, which leads in the extension of the printing direction X.

The invention furthermore relates to a printed product comprising a substrate and a subject to be printed onto the substrate, a method for producing a corresponding printed product, as well as a method for determining at least one printing parameter.

### BACKGROUND OF THE INVENTION

It is known from the prior art to evaluate the printing quality of a printed product by determining various printing parameters. Printing parameters of this type are, for example, the color density, which is a measure for the color-correct reproduction of the primary colors, of which the printed image, hereinafter also referred to as the subject, is printed. The printing quality can furthermore be assessed on the basis of printing parameters, such as the correct position of the individual printing colors to one another, also referred to as the register mark, the presence of doubling, scumming, shifting, or the dot gain, etc.

The determination of these values can occur on a printed product, which is removed from the production, by means of corresponding measuring and evaluation devices, such as, for example, densitometers.

In the case of, for example, web-fed printing presses, that is, in the case of printing presses, which print a web-shaped printing material, it is common practice, however, to check various printing parameters, such as, in particular, the color densities, the register mark, or the color register inline during the ongoing printing process, and to regulate the adherence to the required printing parameters. For this purpose, corresponding sensors, which detect spots on the printed product during the ongoing production and determine the printing parameters accordingly, are used in the printing press.

Print control strips, which consist of a plurality of measuring fields, which are arranged next to one another over the printing material width and thus perpendicularly to the printing direction, are known from the prior art for the determination of the printing parameters on printed products, which are removed from the printing press, as well as for the detection of printing parameters within the machine. These measuring fields usually comprise full tone and halftone areas of the primary colors used for the print for determining the color density or the dot gain, as well as various measuring fields for determining further printing parameters.

To be able to determine and evaluate the printing quality over the entire width of the printing material, measuring fields of this type are arranged over the entire printing width, which generally corresponds essentially to the printing material width.

In the case of printing presses, which use separate devices of such as ink keys or color nozzles, for regulating the coloring, measuring fields for each printing color are usually arranged in the region of the extension of an ink key/ink zone or of a color nozzle, in order to be able to regulate the coloring in zones.

Print control strips, which, in extension of the printing direction, consist only of one row of measuring fields, which are arranged perpendicularly to the printing direction and thus next to one another in the extension of the substrate width B, are further known from the prior art.

However, print control strips are also known, which consist of a plurality of rows, wherein each row comprises measuring fields, which are arranged next to one another. The print control strips known from the prior art comprise measuring fields in particular for the determination of the color density, which have dimensions of approximately three times three millimeters. However, larger and smaller measuring fields are also known, which is a function of the used sensors as well as of the number of the printing parameters, which are to be determined.

The print control strips known from the prior art are formed as beam running rectilinearly, which can be arranged on the leading or the trailing edge of the printing form and/or of a printed image, or in the center of the printed image when printing several copies in a printed product.

The formation of a rectilinear print control strip is rooted or also justified in the formation of the printing form, for example as printing plate embodied with rectilinearly curved legs, which is usually stretched in rectilinear tensioning channels on the form cylinder, as well as in a printed product comprising edges, which usually run rectilinearly, at least at a right angle, such as newspapers or magazines.

However, there are also applications, such as, for example, in the case of the package printing, in the case of which a printed product and thus the subject does not consist of a plurality of mostly rectangular printed pages, but a plurality of printed images of any shape, for example round, oval, or trapezoidal, have to be arranged in the subject. The number of the printed images and thus copies, which are arranged on a printed product, can be increased significantly by means of a suitable nesting of these printed images, a rectilinear edge of the printing form or the use of a rectilinear print control strip, however, would significantly reduce the number of the printed images and thus copies, which can be arranged on a printing form.

### OBJECT OF THE INVENTION

The invention is thus based on the object of creating a solution, by means of which the monitoring of the printing quality is possible by means of a print control strip comprising a plurality of measuring fields even in the case of a non-rectilinear edge course of the subject with simultaneous optimization of the space requirement and thus of the substrate requirement.

This object is solved by means of a print control strip, a printed product, a method for producing a printed product, and a method for detecting at least one printing parameter according to invention described herein and illustrated by the accompany drawings.

### SUMMARY OF THE INVENTION

The print control strip according to the invention is characterized in that the center of area of at least one measuring field or the leading edge of at least one measuring field is arranged so as to be offset in or opposite to the printing direction X to the center of area of at least one adjacent measuring field of the same row.

The printed product according to the invention is characterized in that a print control strip according to the invention is printed onto the printed product.

The method according to the invention for determining at least one printing parameter is characterized by the detection of the measuring fields, which are contained in the print control strip according to the invention, as well as the storage of the coordinates for each measuring field in the extension of the substrate width B as well as in the extension of the printing direction X.

A design of this type of a print control strip or of a corresponding printed product as well as the methods associated therewith have the advantage that a determination and/or regulation of the printing parameters is possible therewith by means of a print control strip even in the case of maximal utilization of the printed image and even in the case of non-rectilinear course of the printed image.

According to a design of the invention, the centers of area of the measuring fields or the leading edges of the measuring fields of at least one row of the print control strip thus lie on a non-straight line.

This non-straight line, which is spanned by the centers of area or by the leading edges or a point of each leading edge of each measuring field of a row, can at least partially be, for example, a segment of an arc of a circle-shaped line and/or a sinusoidal line and/or a sawtooth-shaped line and/or a trapezoidal line. This line can at least partially have a continuous and/or discontinuous course.

To also be able to detect the measuring fields of a corresponding non-rectilinear print control strip inline and thus in an automated manner by means of at least one sensor, and to be able to evaluate the printing parameters, the coordinates of each measuring field to be detected are stored according to an embodiment of the invention in the extension of the substrate width B as well as in the extension of the printing direction. Either the coordinates of the entire area or the coordinates of a point of the leading edge of a measuring field and/or of a center of area of a measuring field and/or of any point within the measuring field can thereby be stored by each measuring field.

The coordinates for each measuring field can thus be retrieved in the extension of the substrate width B as well as in the extension of the printing direction X during the detection of at least one printing parameter by detection of at least one measuring field by means of at least one sensor, so that, on the one hand, a detection of the measuring fields is ensured, and an assignment of the content of a measuring field, such as, for example, the screening as well the printing color, is also stored and can be assigned.

Preferred further developments of the invention follow from the following description of exemplary embodiments and the drawings.

### BRIEF DESCRIPTION OF THE DRAWINGS

Various exemplary embodiments of the invention will be described in more detail on the basis of the accompanying drawings, without being limited thereto.

FIG. 1 shows a printed product known from the prior art comprising a printed print control strip.

FIG. 2 shows a design of a single-row, rectilinear print control strip known from the prior art.

FIG. 3 shows a design of a two-row, rectilinear print control strip known from the prior art.

FIG. 4 shows an example of a printed product comprising a non-rectilinear subject and rectilinear print control strips.

FIG. 5 shows an exemplary embodiment of a printed product comprising a non-rectilinear subject and non-rectilinear print control strip adapted to the shape of the subject.

FIG. 6 shows an unwinding of the subject on the jacket surface of a printing cylinder.

FIG. 7 shows a detail of a section of a one-row, non-rectilinear print control strip comprising square measuring fields.

FIG. 8 shows a detail of a section of a two-row, non-rectilinear print control strip.

FIG. 9 shows a detail of a section of a one-row, non-rectilinear print control strip comprising round measuring fields.

FIG. 10 shows a detail of a section of a one-row, non-rectilinear print control strip comprising non-uniform measuring fields.

### DESCRIPTION OF EXEMPLARY EMBODIMENTS

FIG. 1 shows a printed product 1, which comprises a substrate 2, onto which a single-color or multi-color subject 3 is printed. To print the substrate 2, which has a printing length L and a substrate width B, the substrate 2 is conveyed in the printing direction X by means of a non-illustrated printing press, and imprinted thereby.

It is thereby generally irrelevant for the present invention, whether the printing press is a sheet-fed printing press for imprinting arcuate substrate 2, or whether it is a web-fed printing press, in the case of which a web-shaped substrate 2 is printed, which is subsequently either separated into individual sheets or is wound up again for the further processing.

To evaluate the printing quality unambiguously and/or to be able to evaluate it during the printing process, a print control strip 10 is mostly printed onto the substrate 2. As illustrated in FIG. 1, this print control strip 10 can be arranged at the leading edge 14 of the printed product 1. Although not illustrated in FIG. 1, it is thus also possible to arrange the print control strip 10 in the region of the trailing edge or, in the case of multiple copies, within the subject 3.

FIG. 2 shows the detail A of FIG. 1 in an enlarged scale. It can be seen thereby that the print control strip 10 consists of a plurality of measuring fields 12 arranged next to one another within a single row 11 in the extension of the substrate width B. Normally, the measuring fields 12, which are adjacent to one another, in each case have a different filling, be it that they are imprinted with a different color or that, in addition to a full tone area, an area comprising a defined screen of the same or of another color is imprinted. Further details relating to the design of the respective measuring fields 12 are known from the prior art.

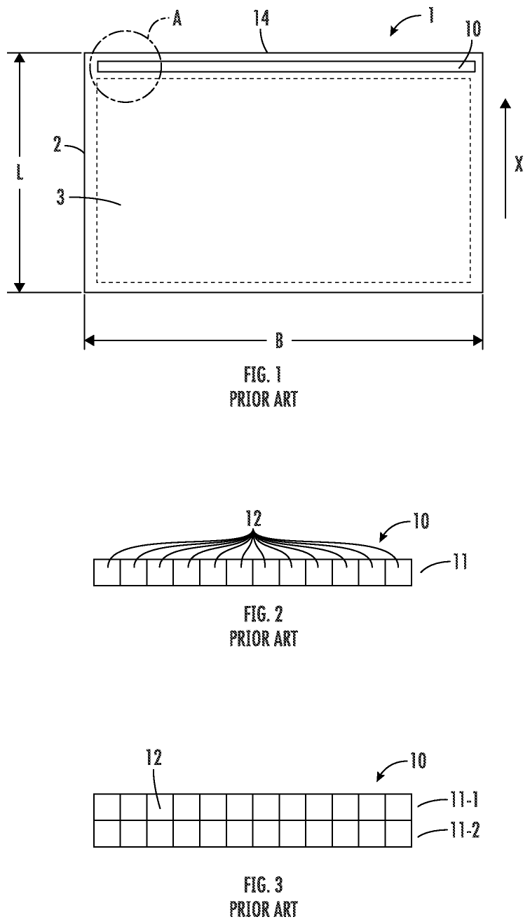

FIG. 3 likewise shows the detail A of the print control strip 10 from the prior art in corresponding enlargement, wherein the print control strip 10 has a plurality of rows 11 arranged one behind the other in the extension of the printing direction X, wherein each row 11 has a plurality of measuring fields 12 arranged next to one another in the extension of the substrate width B perpendicularly to the printing direction X.

The example of FIG. 3 shows a print control strip 10 comprising a first row 11-1 leading in the printing direction X, and a following second row 11-2 of measuring fields 12. Print control strips 10 comprising more than two rows 11 are also known from the prior art, but the number of the rows 11 is not significant for the present invention.

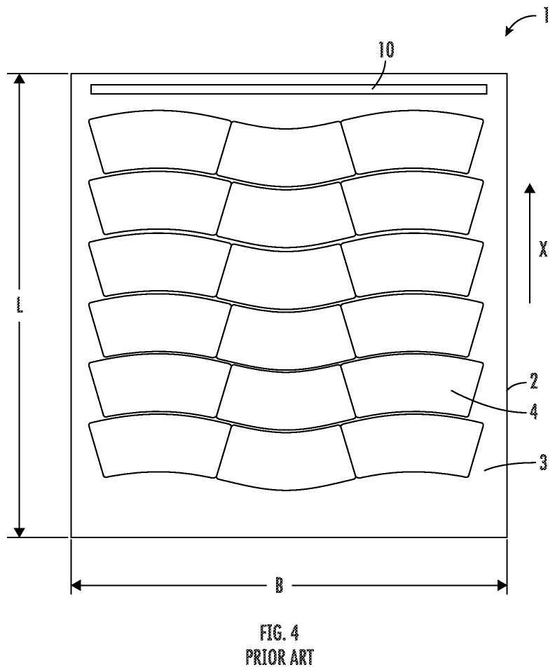

FIG. 4 illustrates an example, in the case of which the use of a rectilinear print control strip 10 from the prior art is disadvantageous. While in the case of subjects 3 with rectilinear and in particular right-angled contour, as illustrated, for example, in FIG. 1, the insertion of a print control strip 10 leads only to a relatively small additional space requirement and thus to a relatively small additional requirement of substrate 2, a rectilinear print control strip 10 thus results to an increased substrate use due to the large portion of unprinted and thus non-usable area in the case of subjects 3 with non-rectilinear contour, as illustrated, for example, in FIG. 4.

Subjects 3 of this type, as illustrated in an exemplary manner in FIG. 4, are used, for example, in the package printing, where the subject 3 comprises copies 4 of any shape, which are preferably arranged in an optimized manner to one another with regard to the space requirement. Copies 4 of this type can have any shape, such as, for example, a circular shape, so that the subject 3 has a non-rectilinear contour in the case of a correspondingly optimized arrangement.

As can be seen in FIG. 4, a correspondingly large space requirement and thus an increased requirement of substrate 2 results for each printed subject 3 in the case of a non-rectilinear and thus non-rectilinear contour of this type of the subject 3 when simultaneously using a rectilinear print control strip 10, because the region between the rectilinear print control strip 10 and the non-rectilinear contour of the subject 3 cannot be used.

FIG. 5 shows the subject 3, which has already been illustrated in FIG. 4, which has the non-rectilinear contour due to the shape of the copies 4 and/or of the arrangement of the copies 4. By using a print control strip 10 according to an exemplary embodiment of the invention, which is adapted to the contour of the subject 3, the distance of the print control strip 10 from the subject 3 can thus on the one hand be kept evenly small over the entire width of the subject 3 or over the entire substrate width B, respectively.

On the other hand, the distance between the non-rectilinear print control strip 10 and the trailing contour of the subject 3, viewed in the printing direction X, can thus likewise be kept small, so that only a minimal additional space is required when arranging the subject 3 including the print control strip 10 around the jacket surface of a form cylinder, and the leading and the trailing edge of the entire printing image can be joined together without gaps.

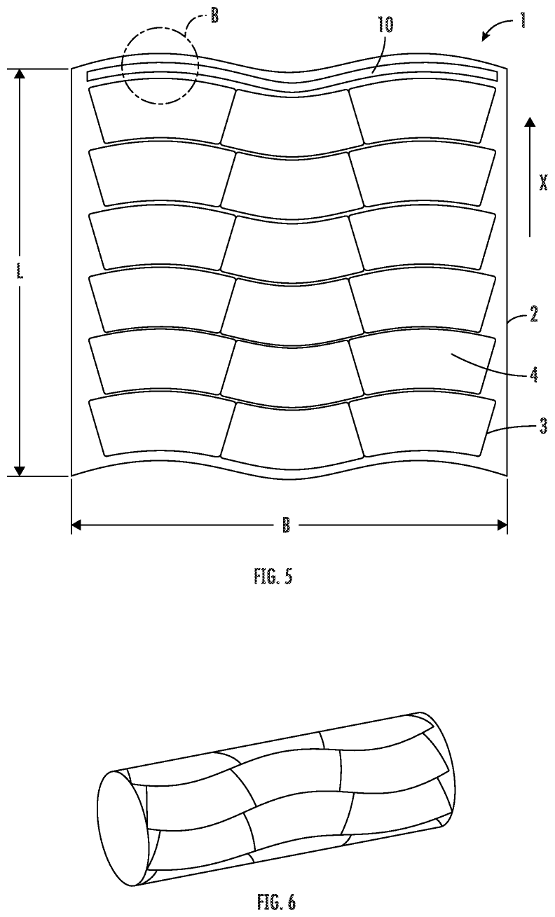

FIG. 6 shows the subject 3 illustrated in FIG. 5 wound around the jacket surface of a form cylinder. It is possible by means of a print control strip 10 of this type according to the invention to arrange a large number of copies 4 including a print control strip 10 on the jacket surface of a form cylinder with minimally unprinted and thus non-usable area of the substrate 2. It is irrelevant thereby whether the form cylinder is an engraved gravure cylinder or a form cylinder with stretched-on printing form, as it is used, for example, in the flexographic or offset printing.

In the case of form cylinders with mounted-on printing form, such as a flexographic printing form or an offset printing plate, the printing form fastened to the form cylinder can also have edges, which are adapted to the contour of the subject 3 accordingly, so that as many copies 4 as possible can be arranged on the jacket surface without excessive loss of space.

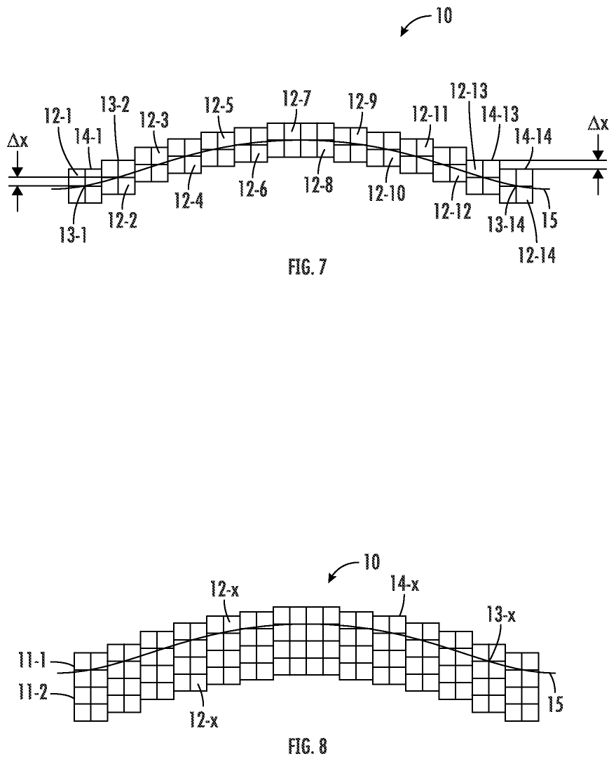

FIG. 7 shows the detail B of the print control strip 10 illustrated in FIG. 5, designed with one row 11 and square measuring fields 12, whereby, according to FIG. 5, the print control strip 10 extends at least over a portion of the substrate width B. When the substrate 2 passes through the printing device in the printing direction X, the print control strip 10 is printed onto the substrate 2 with all printing colors, which are in use, and thus with at least one printing color.

In the extension of the printing direction X, the print control strip 10 comprises one row 11 of measuring fields 12 arranged next to one another perpendicularly to the printing direction X, wherein only the measuring fields 12-1 to 12-14 are illustrated in the detail B according to FIG. 7.

Each measuring field 12 has a center of area 13-1 to 13-14 and an edge 14 leading in the extension of the printing direction X, wherein, for the sake of clarity, only the reference edges of the leading edges 14-1, 14-13, and 14-14 are provided with reference numerals in FIG. 7. It goes without saying, however, that all of the measuring fields 12-1 to 12-14 illustrated in FIG. 7 have a leading edge 14. Each measuring field 12 also comprises a center of area 13.

To adapt the print control strip 10 to the non-rectilinear edge of a subject 3 according to FIG. 5, the center of area 13 of at least one measuring field 12 is arranged so as to be offset in or opposite to the printing direction X to the center of area 13 of at least one adjacent measuring field 12 of the same row 11.

In the case of the exemplary embodiment illustrated in FIG. 7, the center of area 13-2 of the measuring field 12-2 is offset by the offset Δx in the printing direction X to the center of area 13-1 of the measuring field 12-1. With the exception of the measuring fields 12-7 and 12-8, the centers of area 13 arranged next to one another perpendicularly to the printing direction X likewise have an offset Δx to one another in or opposite to the printing direction.

The centers of area 13-1 to 13-14 thus lie on a non-straight line 15, which has an essentially sinusoidal course in the case of the exemplary embodiment shown in FIG. 7. Even though the line 15 illustrated in FIG. 7 and thus essentially the print control strip 10 illustrated in FIG. 5 has a sinusoidal contour due to the subject 3, which is illustrated in an exemplary manner in FIG. 5, it is also possible, as a function of the shape of the copies 4 illustrated in FIG. 5, that the line 15 at least partially assumes any shape, such as, for example, the shape of a segment of an arc of a circle-shaped, of a sawtooth-shaped, or of a trapezoidal line 15.

Although not illustrated in FIG. 5 or in FIG. 7, the line 15, on which the centers of area 13 or the leading edges 14 of the measuring fields 12 of at least one row 11 lie, can at least partially have a continuous course and/or partially have a discontinuous course. The course of the line 15 and thus essentially the contour of the print control strip 10 are essentially a function of the shape of the copies 4 and thus of the contour of the subject 3 as totality of the copies 4, so that abrupt discontinuous courses for the maximum space optimization are thus also possible.

Due to the square shape of the measuring fields 12 as well as due to the identical size of the measuring fields 12 illustrated in FIG. 7, the respective leading edge 14 in the case of the measuring fields 12-1 to 12-7 and 12-8 to 12-14 illustrated in FIG. 7 is arranged so as to be offset in or opposite to the printing direction X to the leading edge 14 of the measuring field 12, which is adjacent perpendicularly to the printing direction X.

In the case of the exemplary embodiment shown in FIG. 7, only the leading edges 14 of the measuring fields 12-7 and 12-8 do not have an offset Δx to one another in the printing direction X.

In the case of an assumed symmetry of the exemplary embodiment shown in FIG. 7 to an imaginary line between the measuring fields 12-7 and 12-8, the leading edge 14-13 of the measuring field 12-13 thus also has the offset Δx to the leading edge 14-14 of the measuring field 12-14, viewed in the printing direction X.

FIG. 8 shows an exemplary embodiment of the detail B from FIG. 5, albeit for a print control strip 10 comprising a plurality of rows 11, namely a first row 11-1 and a second row 11-2.

All of the statement made with regard to the exemplary embodiment shown in FIG. 7 thus apply for the exemplary embodiment shown in FIG. 8, albeit with the difference of a multi-row design of the print control strip 10.

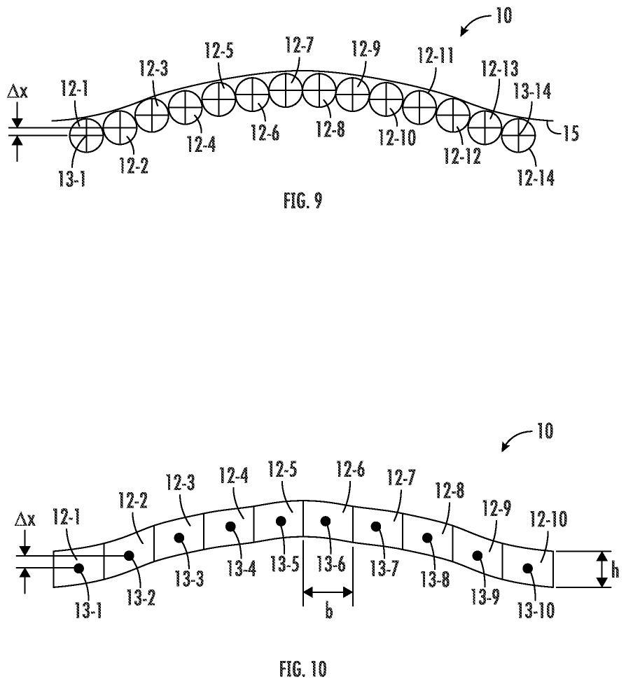

FIG. 9 shows an exemplary embodiment of a print control strip 10 according to the invention as the detail B of FIG. 5, which, in contrast to the print control strips 10 shown in FIGS. 7 and 8, has, for example, round measuring fields 12.

With the exception of the measuring fields 12-7 and 12-8, the remaining measuring fields 12 have an offset Δx to one another in the printing direction X to the respective adjacent measuring field 12, based on the respective centers of area 13. Due to the circular shape of the measuring fields 12, the leading edge 14 as a whole is thus not a preferred reference for the offset Δx to the leading edge 14 of the respective adjacent measuring field 12, because the definition of a specific point is required for this purpose. In the case of this exemplary embodiment, the center of area 13 of a respective measuring field 12 is thus suitable as reference value for the offset Δx.

In contrast to the exemplary embodiments shown in FIGS. 7 and 8, it is possible or simpler, respectively, in the case of the exemplary embodiment shown in FIG. 9, however, to define an enveloping line 15 via the leading edges 14, which thus defines the entire contour of the print control strip 10.

FIG. 10 shows a further possible exemplary embodiment of a print control strip 10 according to the invention. FIG. 10 likewise shows the detail B from FIG. 5.

FIG. 10 shows a design of the measuring fields 12, in the case of which the respective measuring fields 12 have the same measuring field width b perpendicularly to the printing direction X and thus parallel to the substrate width B, but in the case of which each measuring field 12 has a non-straight and measuring field-specific leading edge 14. The leading edge 14 of each measuring field 12 is thus a section of the contour of the print control strip 10, which is preferably adapted to the subject 3. In the case of the exemplary embodiment shown in FIG. 10, the measuring field height h is identical in the case of each measuring field 12, but this does not necessarily have to be the case.

Due to the non-straight shape of the leading edges 14 of the measuring fields 12, the leading edge 14 is a poor reference point for the definition of the offset Δx, but this offset Δx from a measuring field 12 to the adjacent measuring field 12 can occur via the respective centers of area 13. In the case of the exemplary embodiment shown in FIG. 10, the offset Δx in the printing direction X between the center of area 13-1 of the measuring field 12-1 and the center of area 13-2 of the measuring field 12-2 is illustrated in an exemplary manner.

Conversely, this means that in particular as a function of the design of the measuring fields 12, the at least partially non-straight contour of the print control strip 10 in the extension perpendicularly to the printing direction X is defined via the corresponding contour of the subject 3, which is defined by the shape and/or the arrangement of the respective copies 4 to one another, via the offset Δx of the centers of area 13, or via the offset Δx of the leading edges 14, or via the enveloping line 15 of the leading edges 14.

When using a print control strip 10 illustrated in FIG. 5 and FIGS. 7 to 10, said print control strip 10 is printed onto the substrate 2 via the printing form. Comparatively to the image illustrated in FIG. 5, a corresponding printed product 1 has a corresponding print control strip 10.

To determine at least one printing parameter, such as, for example, the color density or the dot gain, at least one measuring field 12 of a print control strip 10 is thus detected by means of at least one non-illustrated sensor, as described under FIG. 5 and FIGS. 7 to 10. The sensor can be at least one iridescent sensor, such as, for example, a CCD camera known from the prior art, which scans the respective measuring fields 12 over the substrate width B.

It is also possible, however, that a plurality of sensors is attached over the substrate width B, in order to scan the substrate 2 simultaneously over the substrate width B. This optical detecting of the measuring fields 12, which are arranged over the substrate width B, of the printed print control strips 10 as well as the determination of the printing parameters is well-known from the prior art.

In the case of the measuring and/or regulating systems known from the prior art for web-fed printing presses, however, the detection is simpler insofar as the print control strip 10, which runs in a straight line and perpendicularly to the printing direction X, always appears again after the same printing length L after each roll-over and thus over the entire substrate width B.

To detect the measuring fields 12 of the print control strip 10 according to the invention over the substrate width B, it is required, however, due to the non-rectilinear shape of the print control strip 10 to store the coordinates of each measuring field 12 to be detected in the extension of the substrate width B as well as in the extension of the printing direction X or to store it in another form, based on a reference point, in the control unit and/or in the evaluation unit of the measuring and/or regulating system to determine the printing parameters or in the controller of the printing press.

This can take place, for example, by storing the geometrical area or the area boundaries of the individual measuring fields 12 or by storing the coordinates of one point of the leading edge 14 and/or the coordinates of the centers of area 13 and/or of any point within each measuring field 12.

It is also possible to store a reference point within the print control strip 10, from where the respective measuring fields 12 are defined via vector data.

Prior to or during the determination of at least one printing parameter, the coordinates or other geometrical information relating to the position of the measuring fields 12 are thus retrieved prior to or during the detection of the measuring fields 12 by means of the at least one sensor, so that it can thus be calculated, at which point on the substrate 2 a specific measuring field 12 is printed, and is detected or can be detected, in order to be able to also subject the data and printing parameters determined therefrom to a master copy and thus to a target/actual comparison and/or to a plausibility check.

That which is claimed is:

1. A print control strip for printing onto a substrate, which moves in a printing direction during a printing process, with a substrate width, which extends perpendicularly to the printing direction, wherein the print control strip extends at least over a portion of the substrate width, wherein the print control strip comprises at least one row in the printing direction, and wherein the at least one row comprises a plurality of measuring fields arranged adjacent one another perpendicularly to the printing direction, and wherein each measuring field has a center of area and a leading edge, which leads in the printing direction, wherein the center of area of at least one measuring field is arranged so as to be offset in or opposite to the printing direction relative to the center of area of at least one adjacent measuring field of the at least one row.

2. A print control strip for printing onto a substrate, which moves in a printing direction during a printing process, with a substrate width, which extends perpendicularly to the printing direction, wherein the print control strip extends at least over a portion of the substrate width, wherein the print control strip comprises at least one row in the printing direction, and wherein the at least one row comprises a plurality of measuring fields arranged adjacent one another perpendicularly to the printing direction, and wherein each measuring field has a center of area and a leading edge, which leads in the printing direction, wherein the leading edge of at least one measuring field is arranged so as to be offset in or opposite to the printing direction relative to the leading edge of at least one adjacent measuring field of the at least one row.

3. The print control strip according to claim 1, wherein the print control strip has one row.

4. The print control strip according to claim 1, wherein the center of areas of the plurality of measuring fields of the at least one row lie on a non-straight line.

5. The print control strip according to claim 4, wherein the centers of area of the plurality of measuring fields of the at least one row lie on an at least partial segment of an arc of a circle-shaped line or on an at least partial segment of a sinusoidal line or on an at least partial segment of a sawtooth-shaped line or on an at least partial segment of a trapezoidal line.

6. The print control strip according to claim 1, wherein the centers of area of the plurality of measuring fields of the at least one row lie on a line with an at least partially continuous and/or discontinuous course.

7. The print control strip according to claim 1, wherein the plurality of measuring fields of the at least one row have the same size or the same area.

8. The print control strip according to claim 1, wherein at least a portion of the plurality of measuring fields have a rectangular or circular shape.

9. A printed product comprising a substrate and a subject printed onto the substrate, wherein a print control strip according to claim 1 is printed onto the printed product.

10. A method for producing a printed product, wherein a subject is printed onto a substrate by means of a printing device, and wherein a print control strip according to claim 1 is printed onto the printed product.

11. A method for determining at least one printing parameter, wherein, to detect the at least one printing parameter, at least one measuring field of at least one print control strip according to claim 1 is detected by means of at least one sensor and is evaluated by a computing unit, wherein the at least one measuring field has coordinates that are detected by the at least one sensor and are stored in the substrate width as well as in the printing direction.

12. The method according to claim 11, wherein a point of the leading edge of at least one of the plurality of measuring fields and/or a center of area of at least one of the plurality of measuring fields and/or of a point within at least one of the plurality of measuring fields are is stored as coordinates of the measuring field.

13. The method according to claim 12, wherein prior to or during the determination of at least one printing parameter, the coordinates for each detected measuring field are retrieved in the substrate width as well as in the printing direction by detection of at least one measuring field by means of the at least one sensor.

14. The print control strip according to claim 2, wherein the print control strip has one row.

15. The print control strip according to claim 2, wherein the leading edges of the plurality of measuring fields of the at least one row lie on a non-straight line.

16. The print control strip according to claim 15, wherein the leading edges of the plurality of measuring fields of the at least one row lie on an at least partial segment of an arc of a circle-shaped line or on an at least partial segment of a sinusoidal line or on an at least partial segment of a sawtooth-shaped line or on an at least partial segment of a trapezoidal line.

17. The print control strip according to claim 2, wherein the leading edges of the plurality of measuring fields of the at least one row lie on a line with an at least partially continuous and/or discontinuous course.

18. The print control strip according to claim 2, wherein the plurality of measuring fields of the at least one row have the same size or the same area.

19. The print control strip according to claim 2, wherein at least a portion of the plurality of measuring fields have a rectangular or circular shape.

20. A printed product comprising a substrate and a subject printed onto the substrate, wherein a print control strip according to claim 2 is printed onto the printed product.
